(19) United States
(12) Patent Application Publication
(10) Pub. No.: US 2022/0412136 A1
(43) Pub. Date: Dec. 29, 2022

(54) Vehicle Door Safety Assembly

(71) Applicant: Tony Dudley, Independence, MO (US)

(72) Inventor: Tony Dudley, Independence, MO (US)

(21) Appl. No.: 17/361,248

(22) Filed: Jun. 28, 2021

(51) Int. Cl. E05C 19/16

(52) U.S. Cl. CPC E05C 19/166; E05Y 2900/518; E05Y 2900/532

(57) ABSTRACT

A vehicle door safety assembly includes an electromagnet that is coupled to an outer wall of a vehicle. The electromagnet produces a magnetic field when the electromagnet is turned on. An attachment is coupled to a door of the vehicle and the attachment is comprised of a magnetic material. The attachment abuts the electromagnet when the door is fully opened. Moreover, the electromagnet magnetically engages the attachment such that the door is retained in an open position. A release button is integrated into the door and the electromagnet is turned off when the release button is depressed thereby facilitating the door to be positioned in a closed position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to door safety devices and more particularly pertains to a new door safety device for retaining a vehicle door in an open position. The device includes an electromagnet that is attached to a vehicle and an attachment that is coupled to a door of the vehicle. The electromagnet magnetically engages the attachment when the door is opened. A release button is attached to the door and the electromagnet is turned off when the release button is depressed for closing the door.

### (2) Description of Related Art Including Information Disclosed Under 37 CFR 1.97 and 1.98

The prior art relates to door safety devices including a door holder that includes a pair of fingers that releasably engage a prong on a door for holding the door in an open position. The prior art discloses a variety of magnetic door holders that each includes plate that is coupled to a door and a magnet that is coupled to a frame which engages the door for retaining the door in an open position. The prior art discloses a door holder device which includes a magnet that is integrated into a bottom edge of a door and a magnet that is integrated into a floor thereby facilitating a door to be retained in an open position.

### BRIEF SUMMARY OF THE INVENTION

An embodiment of the disclosure meets the needs presented above by generally comprising an electromagnet that is coupled to an outer wall of a vehicle. The electromagnet produces a magnetic field when the electromagnet is turned on. An attachment is coupled to a door of the vehicle and the attachment is comprised of a magnetic material. The attachment abuts the electromagnet when the door is fully opened. Moreover, the electromagnet magnetically engages the attachment such that the door is retained in an open position. A release button is integrated into the door and the electromagnet is turned off when the release button is depressed thereby facilitating the door to be positioned in a closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a vehicle door safety assembly according to an embodiment of the disclosure showing a door in a closed position.

FIG. 2 is a perspective in-use view of an embodiment of the disclosure showing a door in an open position.

FIG. 3 is a detail view of an electromagnet and an attachment of an embodiment of the disclosure.

FIG. 4 is a schematic view of an embodiment of the disclosure.

### DETAILED DESCRIPTION OF THE INVENTION

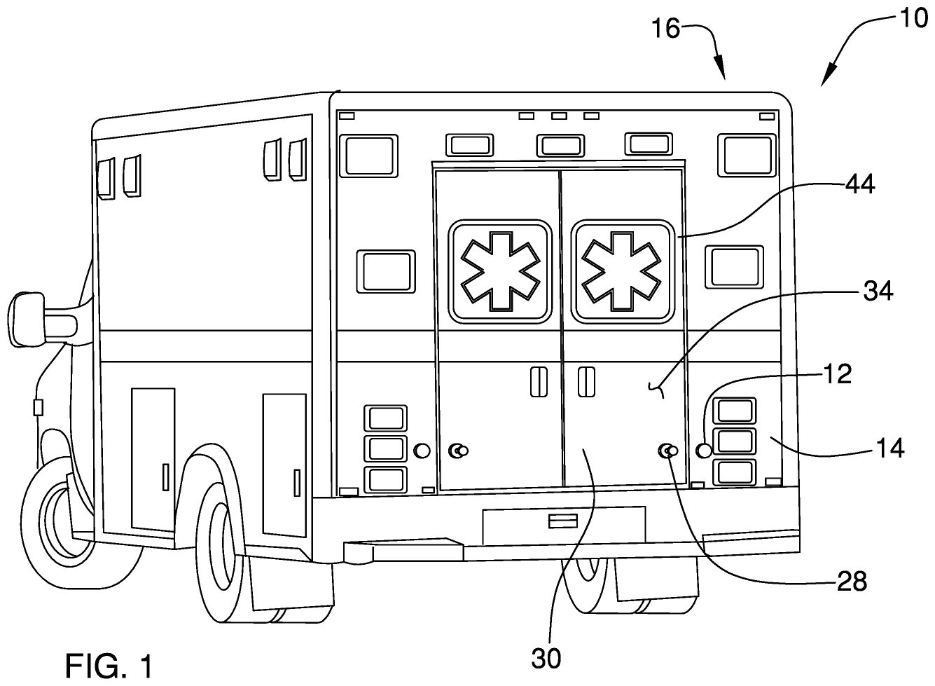

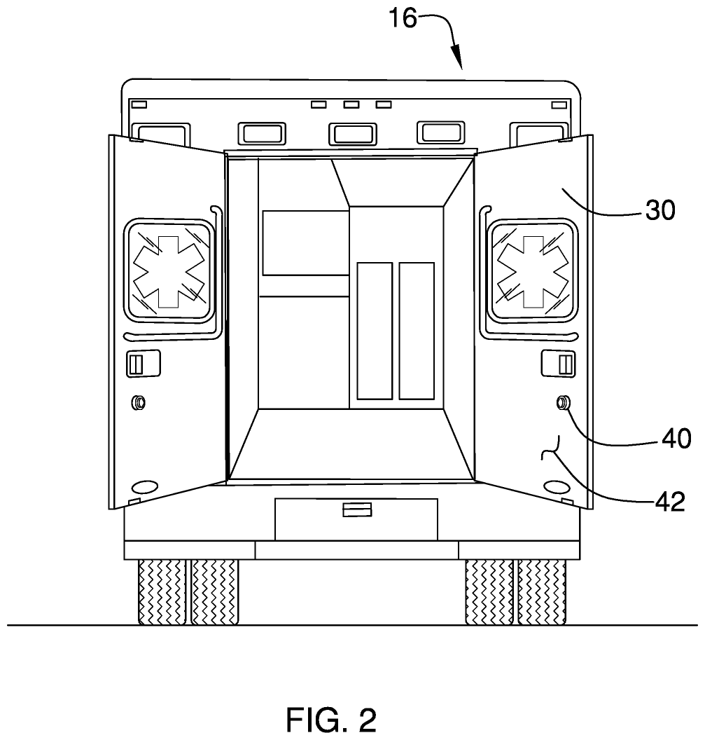

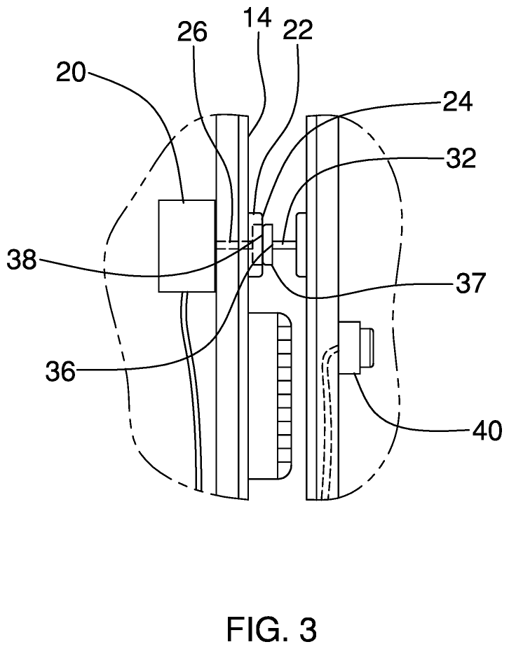

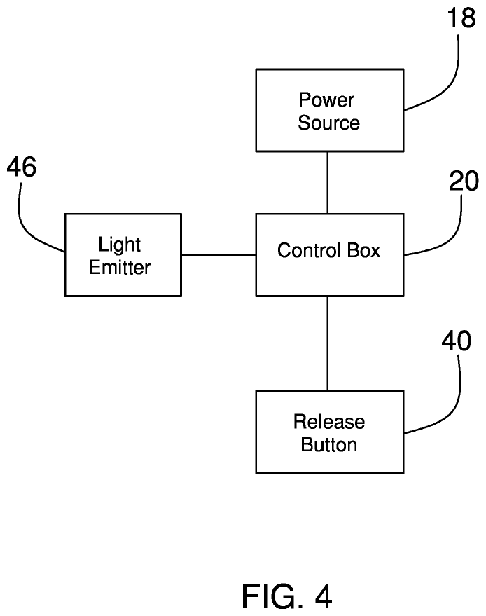

With reference now to the drawings, and in particular to FIGS. 1 through 4 thereof, a new door safety device embodying the principles and concepts of an embodiment of the disclosure and generally designated by the reference numeral 10 will be described.

As best illustrated in FIGS. 1 through 4, the vehicle door safety assembly 10 generally comprises an electromagnet 12 that is coupled to an outer wall 14 of a vehicle 16. The electromagnet 12 produces a magnetic field when the electromagnet 12 is turned on and the electromagnet 12 is electrically coupled to a power source 18 comprising an electrical system of the vehicle 16. The vehicle 16 may be an ambulance or other type of vehicle 16 that has a rear door.

The electromagnet 12 comprises a control box 20 that is attached to the outer wall 14 of the vehicle 16 such that the control box 20 is positioned inside the vehicle 16, and the control box 20 is electrically coupled to the power source 18. The electromagnet 12 includes a plate 22 that is attached to the outer wall 14 of the vehicle 16 such that the plate 22 is positioned outside of the vehicle 16. The plate 22 is comprised of a magnetic material and the plate 22 has a distal surface 24 with respect to the outer wall 14. The electromagnet 12 includes a conductor 26 that extends through the outer wall 14 of the vehicle 16, and the conductor 26 is electrically coupled to the plate 22 and the control box 20. The plate 22 is magnetized when the control box 20 is turned on.

An attachment 28 is provided and the attachment 28 is coupled to a door 30 of the vehicle 16. The attachment 28 is comprised of a magnetic material and the attachment 28 abuts the electromagnet 12 when the door 30 is fully opened. The electromagnet 12 magnetically engages the attachment 28 such that the door 30 is retained in an open position. The attachment 28 comprises a stem 32 that is coupled to and extends away from an outer surface 34 of the door 30, and the stem 32 has a distal end 36 with respect to the outer surface 34. The attachment 28 includes a head 37 that is coupled to the distal end 36 of the stem 32 and the head 37 has an exposed surface 38. The exposed surface 38 abuts the distal surface 24 of the plate 22 when the door 30 is fully opened. Additionally, the head 37 is comprised of a magnetic material and the plate 22 magnetically engages the head 37 when the door 30 is fully opened.

A release button 40 is provided and the release button 40 is integrated into the door 30. The release button 40 is electrically coupled to the electromagnet 12 and the electromagnet 12 is turned off when the release button 40 is depressed. In this way the attachment 28 is disengaged from the electromagnet 12 thereby facilitating the door 30 to be positioned in a closed position. The release button 40 is positioned on an inside surface 42 of the door 30 such that the release button 40 is accessible to a user when the door 30 is opened. Additionally, the release button 40 is electrically coupled to the control box 20.

As is most clearly shown in FIG. 1, the electromagnet 12 may be positioned adjacent to a hinged edge 44 of the door 30. As is additionally shown in FIG. 1, the attachment 28 may be positioned adjacent to the hinged edge 44 of the door 30. Further, the attachment 28 is aligned with the electromagnet 12. A light emitter 46 is integrated into the release button 40 and the light emitter 46 emits light outwardly from the release button 40. The light emitter 46 is electrically coupled to the electromagnet 12 and the light emitter 46 is turned on when the electromagnet 12 engages the attachment 28. In this way the user is visually alerted to the door 30 is locked in the open position. The light emitter 46 may comprise a light emitting diode or other type of electronic light emitter.

In use, the electromagnet 12 is turned on whenever the vehicle 16 is turned on. In this way the attachment 28 magnetically engages the electromagnet 12 when the door 30 is opened. Thus, the door 30 is inhibited from unexpectedly swinging closed and potentially injuring the user. In this way emergency responders, for example, can load a patient into an ambulance without fear of being accidentally struck by the door 30. Additionally, the light emitter 46 is turned on when attachment 28 engages the electromagnet 12. The release button 40 is depressed to turn off the electromagnet 12 thereby facilitating the door 30 to be closed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle door safety assembly for holding a vehicle door in an open position thereby inhibiting the vehicle door swinging closed, said assembly comprising:
an electromagnet being coupled to an outer wall of a vehicle, said electromagnet producing a magnetic field when said electromagnet is turned on, said electromagnet being electrically coupled to a power source comprising an electrical system of the vehicle;
an attachment being coupled to a door of said vehicle, said attachment being comprised of a magnetic material, said attachment abutting said electromagnet when said door is fully opened, said electromagnet magnetically engaging said attachment such that said door is retained in an open position; and
a release button being integrated into said door, said release button being electrically coupled to said electromagnet, said electromagnet being turned off when said release button is depressed such that said attachment is disengaged from said electromagnet thereby facilitating said door to be positioned in a closed position.

2. The assembly according to claim 1, wherein said electromagnet comprises:
a control box being attached to said outer wall of said vehicle such that said control box is positioned inside said vehicle, said control box being electrically coupled to said power source;
a plate being attached to said outer wall of said vehicle such that said plate is positioned outside of said vehicle, said plate being comprised of a magnetic material, said plate having a distal surface with respect to said outer wall; and
a conductor extending through said outer wall of said vehicle, said conductor being electrically coupled to said plate and said control box, said plate being magnetized when said control box is turned on.

3. The assembly according to claim 2, wherein said attachment comprises:
a stem being coupled to and extending away from an outer surface of said door, said stem having a distal end with respect to said outer surface; and
a head being coupled to said distal end of said stem, said head having an exposed surface, said exposed surface abutting said distal surface of said plate when said door is fully opened, said head being comprised of a magnetic material, said plate magnetically engaging said head when said door is fully opened.

4. A vehicle door safety assembly for holding a vehicle door in an open position thereby inhibiting the vehicle door swinging closed, said assembly comprising:
an electromagnet being coupled to an outer wall of a vehicle, said electromagnet producing a magnetic field when said electromagnet is turned on, said electromagnet being electrically coupled to a power source comprising an electrical system of the vehicle, said electromagnet comprising:
a control box being attached to said outer wall of said vehicle such that said control box is positioned inside said vehicle, said control box being electrically coupled to said power source;
a plate being attached to said outer wall of said vehicle such that said plate is positioned outside of said vehicle, said plate being comprised of a magnetic material, said plate having a distal surface with respect to said outer wall; and
a conductor extending through said outer wall of said vehicle, said conductor being electrically coupled to said plate and said control box, said plate being magnetized when said control box is turned on;
an attachment being coupled to a door of said vehicle, said attachment being comprised of a magnetic material, said attachment abutting said electromagnet when said door is fully opened, said electromagnet magnetically engaging said attachment such that said door is retained in an open position, said attachment comprising:
a stem being coupled to and extending away from an outer surface of said door, said stem having a distal end with respect to said outer surface; and
a head being coupled to said distal end of said stem, said head having an exposed surface, said exposed surface abutting said distal surface of said plate when said door is fully opened, said head being comprised of a magnetic material, said plate magnetically engaging said head when said door is fully opened; and
a release button being integrated into said door, said release button being electrically coupled to said electromagnet, said electromagnet being turned off when said release button is depressed such that said attachment is disengaged from said electromagnet thereby facilitating said door to be positioned in a closed position, said release button being positioned on an inside surface of said door wherein said release button is configured to be accessible to a user when said door is opened, said release button being electrically coupled to said control box.

5. A vehicle door safety system for holding a vehicle door in an open position thereby inhibiting the vehicle door swinging closed, said system comprising:
a vehicle having an outer wall and a door;
an electromagnet being coupled to said outer wall of said vehicle, said electromagnet producing a magnetic field when said electromagnet is turned on, said electromagnet being electrically coupled to a power source comprising an electrical system of said vehicle, said electromagnet comprising:
a control box being attached to said outer wall of said vehicle such that said control box is positioned inside said vehicle, said control box being electrically coupled to said power source;
a plate being attached to said outer wall of said vehicle such that said plate is positioned outside of said vehicle, said plate being comprised of a magnetic material, said plate having a distal surface with respect to said outer wall; and
a conductor extending through said outer wall of said vehicle, said conductor being electrically coupled to said plate and said control box, said plate being magnetized when said control box is turned on;
an attachment being coupled to said door of said vehicle, said attachment being comprised of a magnetic material, said attachment abutting said electromagnet when said door is fully opened, said electromagnet magnetically engaging said attachment such that said door is retained in an open position, said attachment comprising:
a stem being coupled to and extending away from an outer surface of said door, said stem having a distal end with respect to said outer surface; and
a head being coupled to said distal end of said stem, said head having an exposed surface, said exposed surface abutting said distal surface of said plate when said door is fully opened, said head being comprised of a magnetic material, said plate magnetically engaging said head when said door is fully opened; and
a release button being integrated into said door, said release button being electrically coupled to said electromagnet, said electromagnet being turned off when said release button is depressed such that said attachment is disengaged from said electromagnet thereby facilitating said door to be positioned in a closed position, said release button being positioned on an inside surface of said door wherein said release button is configured to be accessible to a user when said door is opened, said release button being electrically coupled to said control box.
